(19) United States
(12) Patent Application Publication
(10) Pub. No.: US 2012/0233009 A1
(43) Pub. Date: Sep. 13, 2012

(54) Endorsement Subscriptions for Sponsored Stories

(76) Inventors: Jon Bernhard Fougner, Palo Alto, CA (US); Philip Anastasios Zigoris, San Francisco, CA (US); Gokul Rajaram, Los Altos, CA (US); Ning Li, Newark, CA (US)

(21) Appl. No.: 13/044,506

(22) Filed: Mar. 9, 2011

(51) Int. Cl. G06Q 30/00

(52) U.S. Cl. 705/26.3

(57) ABSTRACT

Methods, apparatuses and systems directed to subscribing to a service for generating and delivering sponsored stories from an organic activity stream in a social networking site. A proxy bidder may aggressively proxy bid for the delivery of the sponsored stories based on a pacing algorithm and feedback loop monitoring the delivery level of sponsored stories.

### TECHNICAL FIELD

The present disclosure relates generally to social networking websites and other systems in which users can form connections with other users, and in particular, to proxying administrative functions such as creation, targeting, and bidding for the promotion of a story from a organic activity stream for delivery to a user.

This disclosure hereby incorporates by reference commonly-owned U.S. utility patent application, U.S. patent application Ser. No. 12/020,745, entitled, “Sponsored Stories Unit Creation From Organic Activity Stream,” previously filed on Feb. 3, 2011.

### BACKGROUND

Social networks, or social utilities that track and enable connections between users (including people, businesses, and other entities), have become prevalent in recent years. In particular, social networking websites allow users to communicate information more efficiently. For example, a user may post contact information, background information, job information, hobbies, and/or other user-specific data to a location associated with the user on a social networking website. Other users can then review the posted data by browsing user profiles or searching for profiles including specific data. Social networking websites also allow users to associate themselves with other users, thus creating a web of connections among the users of social networking website. These connections among the users can be leveraged by the website to offer more relevant information to each user in view of the users' own stated interests in their connections.

Social networking websites typically incorporate a system for connecting members to content that is most likely to be relevant to each member. For example, members may be grouped according to one or more common attributes in their profiles, such as geographic location, employer, job type, age, music preferences, interests, or other attributes. Members of the social networking website or external parties can then use these groups to customize or target information delivery so that information that might be of particular interest to a group can be communicated to that group.

A system, such as a website, that allows users to interact with the system typically stores a record for each user of the system. These records may comprise information provided by the user as well as information gathered by the system related to activities or actions of the user on the system. For example, a system may require a user to enter information such as contact information, gender, preferences, interests, and the like in an initial interaction with the system, which is stored in the user's record. A user's activities on the system, such as frequency of access of particular information on the system, also provide information that can be stored in the user's record. The system may then use information provided by the user and information gathered about the user, to customize interactions of the system with the user. For example, a website selling books may keep track of a user's previous purchases and provide the user with information on related books during subsequent interactions with the system. Information in a user's profile may also be used by the system to target sponsored stories that are of interest to the user. Using information collected from and about users results in a system that is more efficient and beneficial for the user.

Users interacting with the social network may post stories or status updates to a live activity stream, such as a “news feed.” A news feed is a data format typically used for providing users with frequently updated content. A social networking system may provide various news feeds to its users, where each news feed includes content relating to a specific subject matter or topic, and/or other users. Various pieces of content may be aggregated into a single news feed. In some implementations, a social networking system may provide a news feed that includes selected entries corresponding to activities of a user's first-degree contacts and/or pages or topics that a user has indicated an interest. Individual users of the social networking system may subscribe to specific news feeds of their interest. A group of related actions may be presented together to a user of the social networking system in the same news feed. For example, a news feed concerning the event organized through the social networking system may include information about the event, such as its time, location, and attendees, and photos taken at the event, which have been uploaded to the social networking system.

Generally, news feeds are customized for each member; the social network aggregates and displays only the content that meets a predetermined relevancy to the user, as described above. In particular embodiments, information regarding their first-level connections is posted to their news feed. In this manner, members of the social network may quickly access their direct connections' status updates, story postings, and other interactions with the social network in a single stream, obviating the need to individually check their connections' profile pages.

However, given the vast number of contacts the average member of a social network has, and the prodigious amounts of status updates posted by users, it is possible that stories of interest to the user are lost in the unending stream of their newsfeed. This loss of stories is of concern to both sponsors and users. Furthermore, sponsors may wish to pay for increased longevity of a particular story in members' newsfeeds; this functionality unavailable in typical social networking systems.

Typically sponsors pay for an advertisement to be displayed to a member of the social network. In particular embodiments, advertisements may be displayed to a member's home page on the social network, mobile devices, third-party webpages and applications, television and other video streams, or any other particular display accessed by a member of the social network. Sponsored or promoted stories generated from actual stories in users' newsfeeds are more likely to be viewed and interacted with by users, because they generally involve interactions or suggestions by their connected friends, or fan pages that they are connected or subscribed to.

Sponsored stories are processed in an advertisement system in the same manner as any advertisement or social ad. Advertisers or node administrators must bid against each other for placement of their ads or sponsored stories, as well as designate their potential target audience. For example, an advertiser may designate specific users in a particular geographic location, or those with explicit or inferred affinities. Sponsored stories simplifies this process significantly, by automatically displaying a sponsored story to the friends of a user whose social actions generated the newsfeed story promoted to the sponsored stories area, obviating the need to manually write and draw an advertisement creative. However, node administrators must still bid through the advertisement system for the placement of their sponsored stories by entering a bid price in conjunction with the sponsored story or sponsored story campaign. In other systems, node administrators must specify through some other mechanism, such as guaranteed delivery at a fixed, predetermined premium price. This process is time consuming and, due to lack of familiarity with ad targeting by the node administrators, may result in inefficient delivery of the sponsored story.

### BRIEF DESCRIPTION OF THE DRAWINGS

FIG. 1 illustrates the architecture of an example social network.

FIG. 2 illustrates the hardware components of an example social network.

FIG. 3 illustrates the flow of a system implementing endorsement subscriptions for promoting sponsored stories.

FIG. 4 illustrates an example GUI provided to a node administrator to select a subscription level.

FIG. 5 illustrates the logical operation of the proxy bidder.

FIG. 6 illustrates an example computer system.

FIG. 7 illustrates an example network environment.

The figures depict various embodiments of the present disclosure for purposes of illustration only. One skilled in the art will readily recognize from the following discussion that alternative embodiments of the structures and methods illustrated herein may be employed without departing from the principles of the invention described herein.

### DETAILED DESCRIPTION OF EXAMPLE EMBODIMENT(S)

### Overview

In one embodiment, a particular social node administrator, such as the owner of a page or application, may wish to continually promote sponsored stories. The node administrator is provided a simple user interface allowing him to designate a set budget for a given time period. In some embodiments, the budget may be monthly, weekly, daily, or administrator defined. In particular embodiments, the budgets are at pre-set levels such as gold, bronze, or silver, and the various levels are bundled with other advertising features, such as reporting or a vanity URL

A traditional social network is a social structure made of individuals, groups, entities, or organizations generally referred to as “nodes,” which are tied (connected) by one or more specific types of interdependency. As used herein, a “concept” may refer to virtually anything that a user may declare or otherwise demonstrate an interest in, a like, or affinity, for, or a relationship with, such as, by way of example, a sport, a sports team, a genre of music, a musical composer, a hobby, a business (enterprise), an entity, a group, a third party application, a celebrity, a person who is not a registered user, etc. In particular embodiments, each node has, represents, or is represented by, a corresponding web page (“profile page”) hosted or accessible in the social network environment. A concept node may have a corresponding concept profile page (“hub”) in which a plurality of users can add content, make declarations, and express themselves, particularly in relation to the concept. A concept node administrator (herein “node administrator”) is the person or persons maintaining and promoting the concept node.

Upon designating a budget, in particular embodiments, a proxy bidder intelligently bids for delivery of the ads or sponsored stories on behalf of the node administrator. In particular embodiments, the proxy bidder may be embodied as software residing on a server, such as those described in FIG. 7. In particular embodiments, the proxy bidder may be distributed among multiple servers. In particular embodiments, the proxy bidder may be customized to maximize the number of impressions, number of clicks, number of fans, or any other quantifiable objective or mixture thereof, in order to accomplish the node administrator's goals of brand awareness, brand affinity, sales, or exposure to potential customers. In particular embodiments, the proxy bidder increases its bid amount when the node generating the sponsored story is unengaged. In particular embodiments, the proxy bidder measures the delivery of the sponsored story or advertisement and adjusts the pacing of its bids to ensure that the budget is expended but not exceeded for the budgetary time period. In particular embodiments, the proxy bidder determines the audience size for the sponsored story and increases its bid amount for smaller audiences. In particular embodiments, to prevent users of the social network from seeing the same advertisement or sponsored story, the proxy bidder is limited by frequency caps.

In particular embodiments, where the proxy bidder simply cannot bid aggressively enough to meet the budget, due to a lack of endorsements or social actions on the node, the sponsored story system may dynamically generate backfill advertisements for the node, and bid on the delivery of the backfill. In particular embodiments, the backfill advertisements provide user interaction fields that may generate endorsements for the node. In particular embodiments, the pacing of the bidding algorithm is determined by a feedback system that monitors the delivery of the ad or sponsored story.

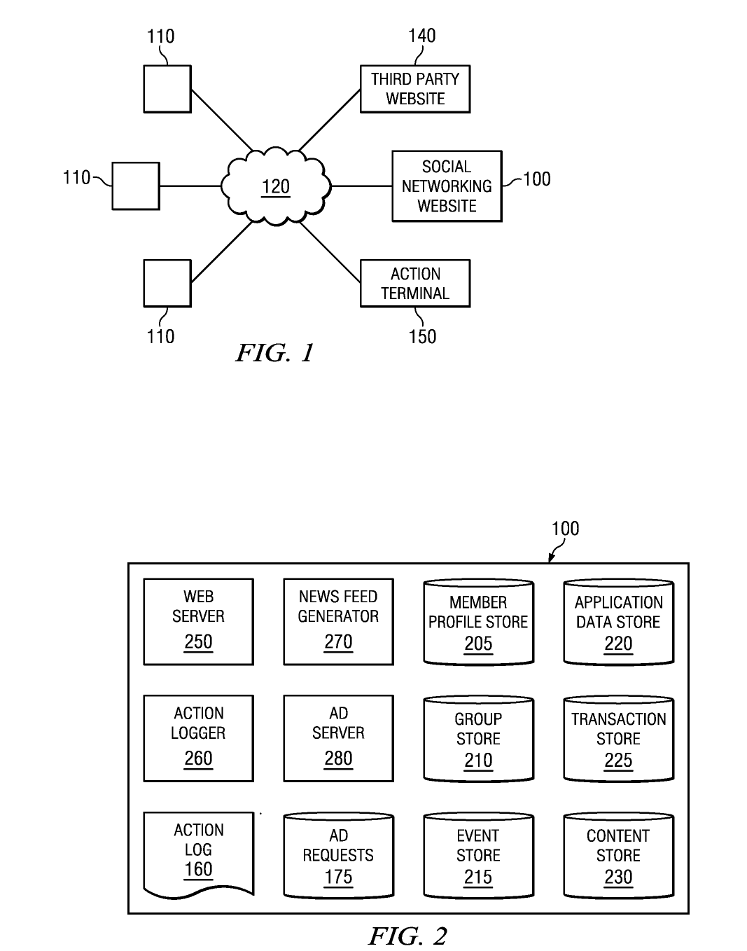

FIG. 1 is a high-level block diagram illustrating a system environment suitable for operation of a social networking website 100. The system environment comprises one or more client devices 110, one or more third-party websites 140, a social networking website 100, and a network 120. In alternative configurations, different and/or additional modules can be included in the system.

Client devices 110 comprise one or more computing devices that can receive member input and can transmit and receive data via network 120. For example, client devices 110 may be desktop computers, laptop computers, smart phones, personal digital assistants (PDAs), or any other device including computing functionality and data communication capabilities. Client devices 120 are configured to communicate via network 120, which may comprise any combination of local area and/or wide area networks, using both wired and wireless communication systems. Third party website 140 and action terminal 150 are coupled to network 120 for communicating messages to social networking website 100 about the members' actions off website 100.

Social networking website 100 comprises a computing system that allows members to communicate or otherwise interact with each other and access content as described herein. Social networking website 100 stores member profiles that describe the members of a social network, including biographic, demographic, and other types of descriptive information, such as work experience, educational history, hobbies or preferences, location, and the like. Website 100 further stores data describing one or more relationships between different members. The relationship information may indicate members who have similar or common work experience, group memberships, hobbies, or educational history. Additionally, the social network host site 120 includes member-defined relationships between different members, allowing members to specify their relationships with other members. For example, these member-defined relationships allow members to generate relationships with other members that parallel the members' real-life relationships, such as friends, co-workers, partners, and so forth. Members may select from predefined types of relationships, or define their own relationship types as needed.

FIG. 2 is an example block diagram of a social networking website 100. Social networking website 100 includes a web server 250, an action logger 260, an action log 160, a newsfeed generator 270, an ad server 280, a database of ad requests 175, a member profile store 205, a group store 210, an event store 215, an application data store 220, a transaction store 245, and a content store 230. In other embodiments, social networking website 100 may include additional, fewer, or different modules for various applications.

Web server 250 links social networking website 100 via network 220 to one or more client devices 210, as well as to one or more third party websites 140. Web server 250 may include a mail server or other messaging functionality for receiving and routing messages between social networking website 100 and client devices 210 or third party websites 140. The messages can be instant messages, queued messages (e.g., email), text and SMS messages, or any other suitable messaging technique.

Action logger 260 is capable of receiving communications from the web server 250 about member actions on and/or off social networking website 100. Newsfeed generator 270 generates communications for each member about information that may be relevant to the member.

In one embodiment, the social networking website 100 also logs actions that a member takes on a third party website 140. The social networking website 100 may learn of the member's actions on the third party website 140 via any of a number of methods. For example, the third party website 140 may send a message to the social networking website 100 when a particular action by a member occurs on the third party website 140. In one example, if the third party website 140 is a commercial website on which members may purchase items, the third party website 140 may inform the social networking website 100 when a member of the social networking website 100 buys an item on the third party website 140.

In another embodiment, the social networking website 100 logs actions taken by its members in the real world. These actions may be recorded by an action terminal, which observes qualifying actions and then communicates that action to the social networking website 100. The communication may be via email, SMS, or any other appropriate means, where the communicated message includes sufficient information for the social networking website 100 to populate the action log 160 with an entry describing the action. The action terminal may comprise any suitable devices or systems for the particular type of action to be tracked.

In one embodiment, the action to be tracked is a credit card transaction, where a member of the social networking website 100 may optionally opt in by registering a credit card. When the registered credit card is used in a qualifying way (e.g., a purchase made at a point of sale), the credit card company (or clearinghouse) sends a message to the social networking website 100. In this scenario, a computing system at the credit card company or clearinghouse serves as a action terminal 150. The message may contain information about the credit card transaction, such the item purchased, the date, and location of the purchase. The social networking system thus tracks real-world actions such as this purchase in the action log 160.

Another example illustrating real-world actions that may be tracked involves the member's location. A member may configure a cellular phone having location technology (e.g., GPS) to communicate the member's location to the social networking website 100. This may be accomplished, for example, by downloading an application to the cellular phone, where the application polls the location unit in the phone and sends a message containing the member's location to the social networking website 100. This may be performed periodically or upon certain triggering events associated with locations. For example, a triggering event can include the member being within to a specific city, or at particular destination such as a restaurant, business, or venue. In this application, the cellular phone (or other GPS-enabled device) serves as the action terminal 150.

Another example illustrating real-world actions that may be tracked involves what program material the member is accessing on a television system. A television and/or set-top receiver may act as an action terminal 150 and transmit a message indicating that a member is viewing (or recording) a particular program on a particular channel at a particular time. Again, these examples are presented to illustrate some of the types of devices and actions that may be captured as actions by a member and communicated to the social networking website 100. A limitless variety of other applications may be implemented to capture real-world actions associated with a particular member and send that information to the social networking website 100.

After an amount of time, the action log 160 will become populated with a number of entries that describe actions taken by the members of the social networking website 100. The action log 160 thus contains a very rich set of data about the actions of the members, and can be analyzed and filtered to identify trends and relationships in the actions of the members, as well as affinities between the members and various objects. This action log can, in some cases, be filtered to include only actions that are likely to be interesting to other members.

These communications may take the form of stories, each story is an information message comprising one or a few lines of information about an action in the action log that is relevant to the particular member. The stories are presented to a member via one or more pages of the social networking website 100, for example in each member's home page or newsfeed page.

Ad server 280 performs an ad selection algorithm 170. Ad server 280 is communicatively coupled to the database of ad requests 175 and to action log 160 for this purpose. In particular embodiments, sponsored stories, although inherently different from advertisements, may be stored and delivered through ad server 280. In particular embodiments, ad server 280 is agnostic to whether delivery is of a sponsored story or an advertisement, and treats requests for the delivery of sponsored stories identically as ad requests 175. Thus, the ad server may proxy bid and target for the delivery of any type of social ad including sponsored stories, static advertisements, or dynamically generated content. In particular embodiments, ad server 280 differentiates between sponsored story and advertisement delivery in accordance with a predetermined algorithm. In particular embodiments, ad server 280 may perform ad section based on a number of targeting factors to maximize the ad/story provider's objectives. In particular embodiments, the ad/story provider may seek to maximize the number of impressions, that is, untargeted, non-unique users that see the ad/story, as possible. In other embodiments, the ad/story provider may seek to maximize the number clicks on his or her ad/story, in such a case, ad system 280 calculates the set of users who have the greatest probability of clicking the ad/story, and displays it to the set.

Ad server 280 receives a request for an ad or sponsored story for a particular member. The ad or sponsored story request describes one or more ads/stories from an advertiser or node administrator for presentation to a particular member. In one embodiment, this request specifies the particular member by including the member's unique member identifier with the request. Ad server 280 then applies targeting criteria, if any, for each of the ad/story requests in the ad request database 175 to the member. An ad/story request may specify a set of targeting criteria to direct the ads/stories to only those members who fit certain criteria. Example targeting criteria may specify any members between the ages of 18 and 30 who have music in their interests. In a particular embodiment, the targeting criteria describe various user demographics, such as gender, age, educational history, geographic area, employment type or other data from the member profile.

The targeting criteria may also describe an association between a member and actions by a member occurring on and/or off the social networking website 100, allowing the targeting criteria to account for more than the member's profile. Examples of actions included in the targeting criteria include sending a message to another member, using a third-party application, joining a group, leaving a group, generating an event description, purchasing or reviewing a product or service using an online marketplace, requesting information from a third-party website or other modification or retrieval of data stored by the social networking website 100 or a third-party website 140. This allows the target criteria to specify one or more actions that when performed by a member identify the member as a potential target for an ad or sponsored story. For example, the targeting criteria may identify members who have recently accessed content describing a particular brand or model of car. Hence, the targeting criteria may also account for actions performed by a member, allowing additional information about member activity and/or interests to be used for selecting ads/stories relevant to the member. Ad server 280 would thus apply these targeting criteria to a particular member and stored actions associated with the particular member to determine whether to use or ignore this ad request for the member. This would then be repeated for each ad/story request, using the corresponding targeting criteria contained in each ad/story request. Ad/story requests having targeting criteria matching a member profile and logged actions associated with a member are identified as candidate ads/stories, which are ads/stories that are potentially relevant to those members whose profiles match the targeting criteria.

In one embodiment, to select which one or ones of the candidate ads/stories to display, ad server 280 computes an expected value for each of the candidate ads/stories. In one embodiment, the expected value is computed as a function of a per-click bid price for the ad/story weighted by an estimated probability that the ad will be clicked by the potential recipient. To estimate the probability that a particular member will click on an ad/story, ad server 280 may compute this probability as a weighted function of the member's affinities for the targeting criteria associated with the candidate ad/story. Additionally, computation of the expected value for each of the candidate ads/stories may include data about the advertiser or node administrator requesting the ad/story. For example, the number of members targeted by the advertiser or node administrator may affect the bid price, allowing candidate ads/stories from an advertiser having a lower bid amount but a larger group of potentially accessible members to have a higher expected value than candidate ads from an advertiser having a higher bid amount but a smaller group of potentially accessible members. Alternatively, the expected value is weighted by the amount of common data in the targeting criteria and a member's profile, so that ads/stories more likely to be accessed by the user and provide revenue to social networking website 100 have a higher expected value. For example, if the targeting criteria include 8 elements and a member profile matches four elements of the targeting criteria the expected value is weighted by the ratio of the number of target criteria elements matching the member profile to the number of target criteria, or 0.5 in this example. In other embodiments, different functions of the targeting criteria and member profile are used to weight the expected value

In particular embodiments, in order to optimize the targeting and selection of ads for users of a social network, social information gathered on and off the social network about a user is leveraged to infer interests about users of the social network. A social network may maintain a social graph that identifies the mapping of connections among the users of a social network, and the social network may also maintain profiles that contain full or partial information about each of the users in the social network. One or more advertisements, or ads, available to the social network may contain targeting criteria for determining whether the ad should be targeted to a particular user. While the social network may have sufficient information about some of its users to apply the targeting criteria, the social network may not have sufficient information about other users to apply the targeting criteria. Rather than missing out on the opportunity to target ads to this latter group of users, embodiments use the information for other users to whom a particular user is connected when the social network does not have sufficient information to apply the targeting criteria to the user. This may be thought of as “inferential” ad targeting because a user's likely interest in a particular ad is inferred based on whether that user's connections (e.g., friends in the social network) are good candidates for the ad based on its targeting criteria.

In particular embodiments, user profile information for a user of a social networking system is inferred based on information about user profile of the user's connections in the social networking system. The inferred user profile attributes may include age, gender, education, affiliations, location, and the like. To infer a value of a user profile attribute, the system may determine an aggregate value based on the attributes of the user's connections. A confidence score may also be associated with the inferred attribute value. The set of connections analyzed to infer a user profile attribute may depend on the attribute, the types of connections, and the interactions between the user and the connections. The inferred attribute values may be used to update the user's profile and to determine information relevant to the user to be presented to the user (e.g., targeting advertisements to the user based on the user's inferred attributes).

In particular embodiments, ad server 280 runs an effective cost-per-impression (eCPM) auction, where cost-per-click (CPC) ads/stories as described above compete with standard cost-per-impression (CPM) ads/stories. In such an embodiment, ad server 280 multiplies the expected value calculated in paragraph 0038 by 1000 to obtain the eCPM for the ad/story. The eCPM is used in a standard CPM auction against CPM ad/stories.

Once the expected values are computed for the candidate ads or sponsored stories, ad server 280 selects ads/stories for the candidate with the highest expected value. The selected ads/stories are thus the ones that will bring the most revenue value to the social networking website 100 because of the probability that the they will be selected and the bid amount that will be paid to the website 100 if it is selected.

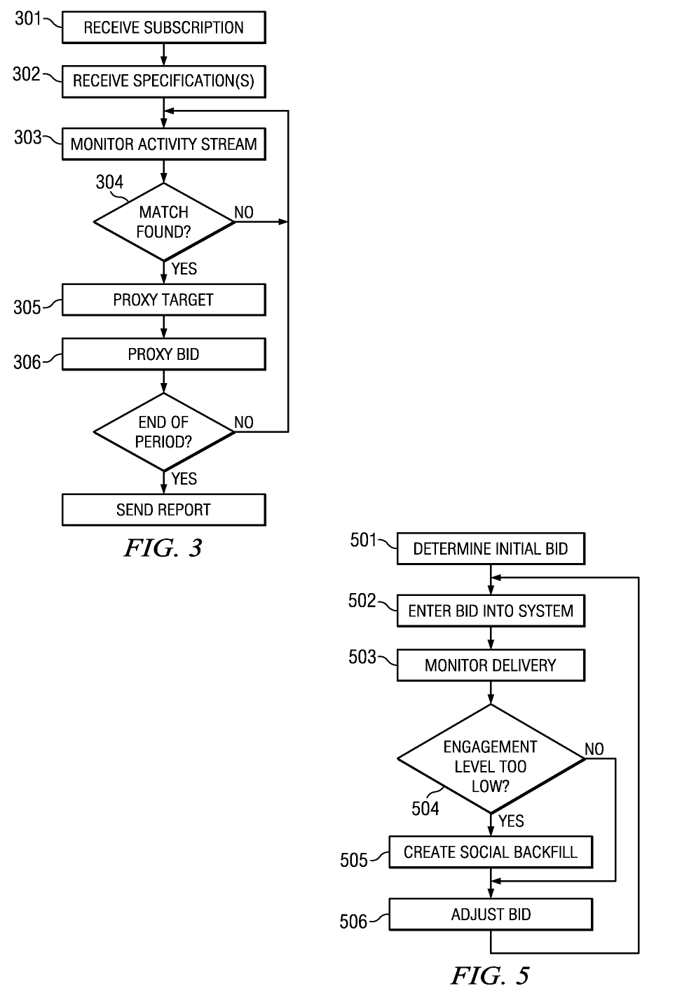

FIG. 3 illustrates the flow of a system implementing endorsement subscriptions for promoting sponsored stories. At step 301, the endorsement subscriptions system receives a subscription from a node administrator. The subscription may include various information, such as a budget and time period, such as, for example, $10 per day or $100 per month.

In step 302, the node administrator inputs one or more story specifications. In particular embodiments, the story specification also includes the type of social interactions on the node administered by the node administrator that he or she wishes to promote as a sponsored story. For example, a node on the social network may include but is not limited to a page, a place, a person, or a company with multiple locations. The node administrator may specify in the story specification which social interactions on the node he or she wishes to promote as a sponsored story. The social interactions include, but are not limited to tagging, sharing, “liking”, commenting on media or mentioning a user in a status update or comment, RSVPing or inviting a user to an event or game, and the like. Other user interactions include but are not limited to “check-ins” and other location-based social interactions, sharing a link from a third-party website, “liking” a post or page from a third-party site, buying, redeeming, or subscribing to deals and other promotions, and interacting with an application on or off the social network. In particular embodiments, inferred social actions on the node are also detected. Inferred social actions are performing a social action on a posting or comment by the node or node administrator.

In particular embodiments, the story specification information may also include targeting criteria as described above. Targeting may be based one or more factors such as member demographics (age, gender, location, birth date, age, education level, employers, employment type, work history and experience, hobbies, and or preferences. These factors may draw from explicit member statements such as listing it on their profile, connections to other members or entities, or through user-entered text on and off the social networking site. In another embodiment, these factors may be implicitly or inferred by the social network. In particular embodiments, the node administrator may specify “broad targeting” criteria, or targeting by a single factor, such as age, across all users and actions.

In step 303, a sponsored story system monitors an activity stream of all the aggregated social stories generated in social network 100, searching for matches to any of the received sponsored story specifications. Social stories comprise any story generated by interactions of user or concept nodes. If a match is found in step 304, the story in the activity stream is formatted into a sponsored story, and in step 305, the proxy bidder performs proxy targeting and bids on the delivery of the sponsored story.

In particular embodiments, proxy targeting is another form of machine learning that reduces the involvement required of node administrators. For example, if a node administrator does not specify any targeting, the system will determine whether there is a natural demographic for the node from the content of the node page, such as if there is a location associated with the page, the sponsored stories will be automatically targeted at users in the geographic region. Ad system 280 adjusts proxy targeting by monitoring the response of users who are displayed the ad or sponsored story. For example, if a sponsored story is initially targeted toward a set of users, and only a subset of the targeted set responds, ad server 280 may look for the common demographic between the responding users, and specifically target those users.

In step 306, the proxy bidding algorithm, as described in FIG. 5, intelligently bids on the delivery of the sponsored story or advertisement ad server 280.

The process is repeated for all activity stream stories matching the story specifications until the time period in the subscription ends. In Step 307, ad system 280 sends a report of the delivery to the node administrator.

In particular embodiments, the reports may deliver a number of statistics about the delivery of the sponsored story to users. For example, the report may include basic statistics, such as the number of users reached, the number of impressions, the number of clicks, and the number of inline actions, such as playing a video, liking the post, etc. In particular embodiments, the report may include conversion tracking, such as engagement to the node post-delivery of the sponsored story, or post-impression. The conversion tracking may, in particular embodiments, consider user actions off the social network. In particular embodiments, the level of reporting provided is dependent on the subscription level selected by the node administrator.

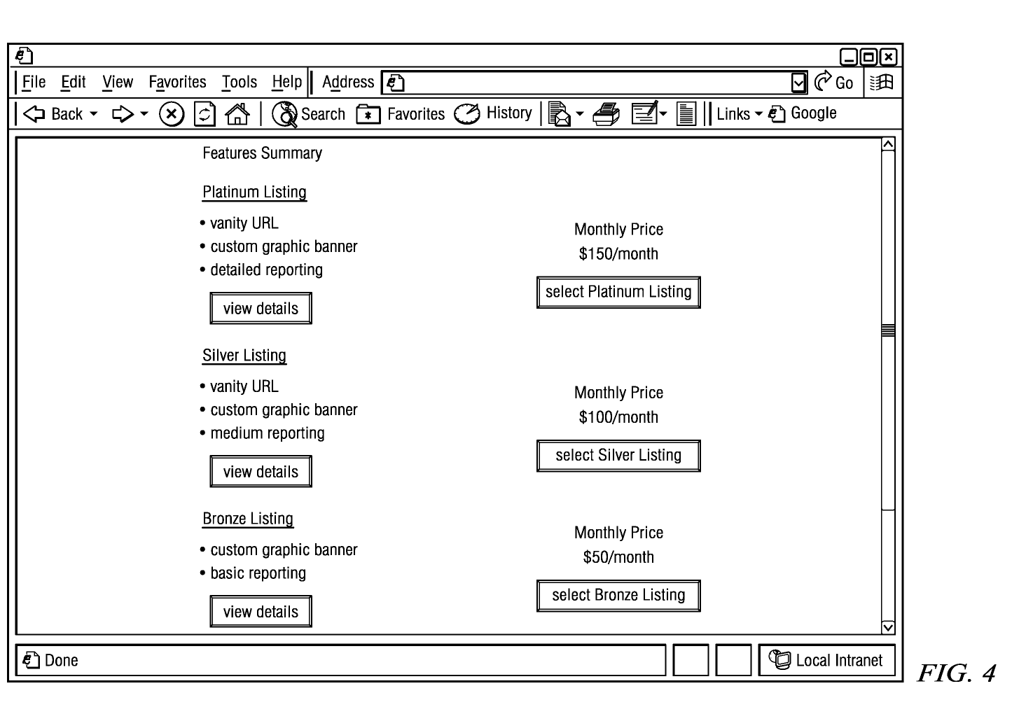

FIG. 4 illustrates an example GUI provided to a node administrator to select a subscription level. In this example, the node administrator is given three monthly pricing levels, Platinum, Silver and Bronze. In particular embodiments, the levels correspond to the budget the proxy bidder is allowed to expend every month. In particular embodiments, the various levels also include features that are applied to the node administrator's account. For example, one pay-for-technology feature is to include a custom vanity URL, even for nodes that would not normally meet the requirements for obtaining a vanity URL. In particular embodiments, certain levels include greater detail reporting.

In particular embodiments, the subscription GUI allows the node administrator to enter an arbitrary recurring monthly budget. In particular embodiments, the subscription GUI allows the node administrator to enter an arbitrary recurring budget for an arbitrary time period. In particular embodiments, the node administrator uses a GUI including a slider, drop-down, or free text field to enter the arbitrary budget. In particular embodiments, the node administrator is provided a set of goals for the sponsored story campaign, such as maximizing the number of impressions, views, or clicks, or some weighted mixture of multiple goals.

FIG. 5 illustrates the operation of the proxy bidding algorithm. In step 501, the initial bid for a sponsored story is determined. In particular embodiments, the node administrator enters an initial bid price. In particular embodiments, the proxy bidder determines the initial bid price based upon various factors related to the sponsored story. Such factors include, but are not limited to: the budget for the specified time period, the level of engagement on the node (the number of endorsements or social actions on the node), the potential audience size, and the type of endorsement generating the sponsored story. However, as explained below, the initial bid is not deterministic of the overall bidding strategy because the proxy bidder receives feedback by monitoring the delivery of the sponsored story, and adjusts the bid according to this feedback. At step 502 the bid is entered into the system.

At step 503, the proxy bidder monitors the delivery of the sponsored story. A number of factors affect the delivery of the sponsored story. First, the engagement level of the node is considered. In particular embodiments, the engagement level is the multiplicative product of the number of sponsored stories and the average number of impressions by eligible connections of the user performing the endorsement generating the sponsored story, or, in the case where the endorsement is generated by a node administrator, by the fans of the node. All other factors being equal, a node with low engagement, that is, few endorsements of the node, will inherently have fewer sponsored stories to be displayed to users. Similarly, a node consistently engaged by users with few or no friends, or by a node administrator with few fans, will be considered a relatively unengaged nodes. The proxy bidder monitors the degree of engagement of the node, and bids more aggressively at higher prices for sponsored stories generated by nodes with low engagement. Conversely, sponsored stories that are generated by a highly-engaged node, i.e., a node that is frequently endorsed by users and therefore has a large number of sponsored stories, are not bid on as aggressively by the proxy bidder.

Another factor affecting the delivery of a sponsored story is the potential audience size of the story. Node administrators may wish to only display their sponsored stories to a precise demographic set of users, such as users who have an affinity for a certain music, or users located in a given geographic region. Furthermore, different types of endorsements have different temporal lives. For example, check-ins may be relevant only for a brief amount of time after the endorsement. Thus, based on the specified target audience of the sponsored story and the type of endorsement generating the sponsored story, the potential audience varies significantly. All other factors being equal, the proxy bidding algorithm may bid more aggressively (higher) for sponsored stories with a smaller audience.

Another factor affecting the delivery of a sponsored story is the frequency cap. In particular embodiments, all sponsored stories are subject to a frequency cap, which limits the number of times a given users may be shown a specific sponsored story in a predetermined time period. For example, the frequency cap may limit display of a specific sponsored story to no more than three times in a single day or six times in a week. In particular embodiments, the frequency cap is set to five impressions per day, and the weekly limit is three times the daily limit; i.e., fifteen per week.

The proxy bidder is largely controlled by a pacing algorithm, which increases or decreases the bid amount for a sponsored story such that the budget amount specified in the endorsement subscription is fully expended but not exceeded by the end of the designated time period. This pacing algorithm takes into account the factors listed above, as well as empirical delivery data for a given sponsored story or sponsored story campaign. The function of the proxy bidder pacing algorithm is best described by way of example.

Take for example a particular node administrator who subscribes to $100/month of sponsored stories. After entering an initial bid (the bid amount is not controlling of the overall bidding strategy), the proxy bidding algorithm monitors the delivery of the sponsored stories. In particular embodiments, the pacing algorithm will perform a simple calculation as to whether the (endorsements/hour)*(current bid price)*(hours until time period expires) exceeds $100. If the node is highly engaged, that is, there are multiple endorsements to bid on, and continuing at the current bid price will exceed $100 by the end of the month, then the proxy bidder reduces its bid (Step 506). Conversely, for a unengaged node, where the rate of endorsements is low, continuing at the current bid will result in delivery of significantly less than $100 by the end of the month. Thus, the proxy bidder will bid more aggressively on the endorsements that enter ad server 280.

The proxy bidder takes into account all the aforementioned factors when bidding by continually monitoring the empirical delivery of the node's sponsored stories. Thus, the initial bid is not of utmost significance, because the proxy bidder, through use of the pacing algorithm, will bid on a price that ensures delivery of the node endorsements at a level commensurate with the node administrator's subscription level. Thus, because of the feedback system, the bid price employed by the proxy bidder is continually in flux.

However, there are particular scenarios where the proxy bidder simply cannot bid high enough to meet the subscription amount. The first scenario is where the level of engagement is simply too low. For example, if the proxy bidder is bidding as aggressively as possible; i.e., winning every sponsored story auction, but there are simply no endorsements on the node generating sponsored stories, the proxy bidder mathematically cannot generate the delivery value meeting the subscription budget. The second scenario this occurs is when the endorsements are hitting the frequency cap. For example, if the proxy bidder could deliver more sponsored stories to users by increasing its bid amount; i.e., it is not yet at the maximum bid, but doing so would result in delivery of the same sponsored story to users in excess of the frequency cap, and there are no other endorsements to bid on, the proxy bidding system cannot deliver the budget's worth of sponsored stories. Another scenario where delivery value cannot meet the subscription amount occurs when the node administrator or proxy targeter has specified very narrow targeting, such as a small geographic region.

In such a case, the pacing algorithm determines whether the observed delivery is below a dynamically calculated threshold. In step 504, the pacing algorithm determines whether the engagement level is below this threshold, then at step 505, the sponsored story system generates backfill for the node.

Backfill refers to dynamically generated advertisements resembling sponsored stories for a node. In particular embodiments, they are generated by sponsored story system without any administrator creative. Once the backfill is created, it is bid into the system at Step 502 like any other sponsored story, and the proxy bidder returns to monitoring the delivery of the backfill in Step 503.

In particular embodiments, the backfill includes action items for the user to interact on, such as links to perform social actions on the node, or on a post of the node. These action items, when interacted on by users, create endorsements for the node, which may in turn be promoted to sponsored stories. Thus, backfill generates actual node engagement to bid into sponsored stories. In this sense, the generation of backfill may be considered “priming the pump,” as after it is bid into the system, node engagement will naturally increase. The pacing algorithm, by consistently monitoring the delivery of sponsored stories and node engagement, can continually deliver backfill until node engagement reaches a level wherein the budget may be expended based upon actual user engagement. Thus the proxy bidder attempts to delivery a level of sponsored stories delivery commensurate with the node administrator's subscription level.

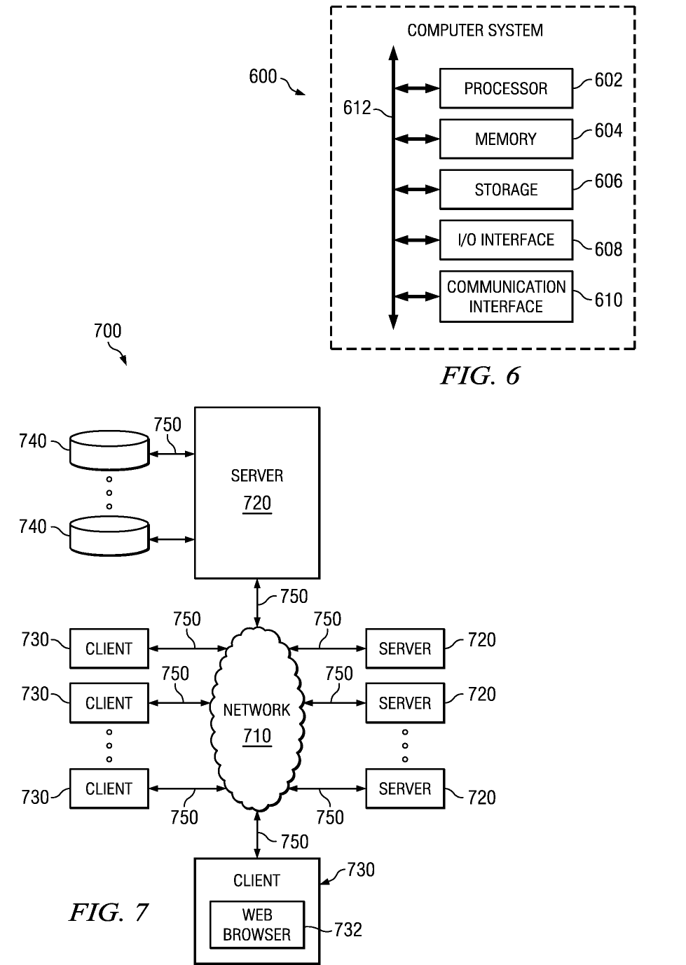

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple datacenters; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 02 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include an HDD, a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, reference to a computer-readable storage medium encompasses one or more non-transitory, tangible, computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 602 (such as, for example, one or more internal registers or caches), one or more portions of memory 604, one or more portions of storage 606, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

FIG. 7 illustrates an example network environment 700. This disclosure contemplates any suitable network environment 700. As an example and not by way of limitation, although this disclosure describes and illustrates a network environment 700 that implements a client-server model, this disclosure contemplates one or more portions of a network environment 700 being peer-to-peer, where appropriate. Particular embodiments may operate in whole or in part in one or more network environments 700. In particular embodiments, one or more elements of network environment 700 provide functionality described or illustrated herein. Particular embodiments include one or more portions of network environment 700. Network environment 700 includes a network 710 coupling one or more servers 720 and one or more clients 730 to each other. This disclosure contemplates any suitable network 710. As an example and not by way of limitation, one or more portions of network 710 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 710 may include one or more networks 79.

Links 750 couple servers 720 and clients 730 to network 710 or to each other. This disclsoure contemplates any suitable links 750. As an example and not by way of limitation, one or more links 750 each include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) links 750. In particular embodiments, one or more links 750 each includes an intranet, an extranet, a VPN, a LAN, a WLAN, a WAN, a MAN, a communications network, a satellite network, a portion of the Internet, or another link 750 or a combination of two or more such links 750. Links 750 need not necessarily be the same throughout network environment 700. One or more first links 750 may differ in one or more respects from one or more second links 750.

This disclosure contemplates any suitable servers 720. As an example and not by way of limitation, one or more servers 720 may each include one or more advertising servers, applications servers, catalog servers, communications servers, database servers, exchange servers, fax servers, file servers, game servers, home servers, mail servers, message servers, news servers, name or DNS servers, print servers, proxy servers, sound servers, standalone servers, web servers, or web-feed servers. In particular embodiments, a server 720 includes hardware, software, or both for providing the functionality of server 720. As an example and not by way of limitation, a server 720 that operates as a web server may be capable of hosting websites containing web pages or elements of web pages and include appropriate hardware, software, or both for doing so. In particular embodiments, a web server may host HTML or other suitable files or dynamically create or constitute files for web pages on request. In response to a Hyper Text Transfer Protocol (HTTP) or other request from a client 730, the web server may communicate one or more such files to client 730. As another example, a server 720 that operates as a mail server may be capable of providing e-mail services to one or more clients 730. As another example, a server 720 that operates as a database server may be capable of providing an interface for interacting with one or more data stores (such as, for example, data stores 790 described below). Where appropriate, a server 720 may include one or more servers 720; be unitary or distributed; span multiple locations; span multiple machines; span multiple datacenters; or reside in a cloud, which may include one or more cloud components in one or more networks.

In particular embodiments, one or more links 750 may couple a server 720 to one or more data stores 740. A data store 740 may store any suitable information, and the contents of a data store 740 may be organized in any suitable manner. As an example and not by way or limitation, the contents of a data store 740 may be stored as a dimensional, flat, hierarchical, network, object-oriented, relational, XML, or other suitable database or a combination or two or more of these. A data store 740 (or a server 720 coupled to it) may include a database-management system or other hardware or software for managing the contents of data store 740. The database-management system may perform read and write operations, delete or erase data, perform data deduplication, query or search the contents of data store 740, or provide other access to data store 740.

In particular embodiments, one or more servers 720 may each include one or more search engines 722. A search engine 722 may include hardware, software, or both for providing the functionality of search engine 722. As an example and not by way of limitation, a search engine 722 may implement one or more search algorithms to identify network resources in response to search queries received at search engine 722, one or more ranking algorithms to rank identified network resources, or one or more summarization algorithms to summarize identified network resources. In particular embodiments, a ranking algorithm implemented by a search engine 722 may use a machine-learned ranking formula, which the ranking algorithm may obtain automatically from a set of training data constructed from pairs of search queries and selected Uniform Resource Locators (URLs), where appropriate.

In particular embodiments, one or more servers 720 may each include one or more data monitors/collectors 724. A data monitor/collection 724 may include hardware, software, or both for providing the functionality of data collector/collector 724. As an example and not by way of limitation, a data monitor/collector 724 at a server 720 may monitor and collect network-traffic data at server 720 and store the network-traffic data in one or more data stores 740. In particular embodiments, server 720 or another device may extract pairs of search queries and selected URLs from the network-traffic data, where appropriate.

This disclosure contemplates any suitable clients 730. A client 730 may enable a user at client 730 to access or otherwise communicate with network 710, servers 720, or other clients 730. As an example and not by way of limitation, a client 730 may have a web browser, such as MICROSOFT INTERNET EXPLORER or MOZILLA FIREFOX, and may have one or more add-ons, plug-ins, or other extensions, such as GOOGLE TOOLBAR or YAHOO TOOLBAR. A client 730 may be an electronic device including hardware, software, or both for providing the functionality of client 730. As an example and not by way of limitation, a client 730 may, where appropriate, be an embedded computer system, an SOC, an SBC (such as, for example, a COM or SOM), a desktop computer system, a laptop or notebook computer system, an interactive kiosk, a mainframe, a mesh of computer systems, a mobile telephone, a PDA, a netbook computer system, a server, a tablet computer system, or a combination of two or more of these. Where appropriate, a client 730 may include one or more clients 730; be unitary or distributed; span multiple locations; span multiple machines; span multiple datacenters; or reside in a cloud, which may include one or more cloud components in one or more networks.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although the foregoing embodiments have been described in the context of a social network system, it will apparent to one of ordinary skill in the art that the invention may be used with any electronic social network service and, even if it is not provided through a website. Any computer-based system that provides social networking functionality can be used in accordance with the present invention even if it relies, for example, on e-mail, instant messaging or other form of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a social network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a first subscription from a node administrator;
receiving a first sponsored story specification from the node administrator, the first sponsored story specification including particular endorsements of the node corresponding user actions on the node;
monitoring an organic activity stream for endorsements of the node matching the particular endorsements in the first sponsored story specification;
upon finding a match; converting the endorsements from the organic activity stream into a first sponsored story; and
automatically proxy bidding, in accordance with the received subscription, in a sponsored stories system for the display of a first sponsored story generated in accordance with the first sponsored story specification to one or more members of a social network.

2. The method of claim 1, wherein the subscription comprises a value corresponding to a fiscal budget.

3. The method of claim 2, wherein the subscription further comprises a time duration for expending the fiscal budget.

4. The method of claim 1, user actions on the node comprising checking in to a location associated with the node.

5. The method of claim 1, user actions on the node comprising liking the node.

6. The method of claim 1, user actions on the node comprising posting to the wall of the page associated with the node.

7. The method of claim 1, the user actions on the node comprising user actions on the node administrator's posts.

8. The method of claim 1, automatically proxy bidding comprising:
placing bids based on a bidding algorithm and the received subscription.

9. The method of claim 7, wherein the bidding algorithm comprises:
determining the engagement level of the node; and
bidding more aggressively as the engagement level decreases.

10. The method of claim 7, wherein the bidding algorithm comprises pacing the bids so that the fiscal budget is fully expended but not exceeded by the end of the time duration.

11. The method of claim 10, wherein the pacing of bids is adjusted based on observed consumption.

12. The method of claim 7, wherein the bidding algorithm is subject to a frequency cap.

13. The method of claim 7, wherein the subscription further comprises an optimization goal specified by the node administrator, and the bidding algorithm bids to meet the optimization goal.

14. The method of claim 13, wherein the optimization goal is to maximize the number of impressions on users of the social network.

15. The method of claim 13, wherein the optimization goal is to maximize the number of clicks, and the bidding algorithm bids on sponsored story display to users of the social network who have the highest probability of clicking the sponsored story.

16. The method of claim 7, wherein the bidding algorithm comprises:
determining the potential audience size for the sponsored story; and
bidding more aggressively as the potential audience size decreases.

17. The method of claim 16, wherein determining the potential audience size comprises calculating an audience size based on social graph factors.

18. The method of claim 16, wherein determining the potential audience size comprises calculating an audience size based on geographic or demographic factors.

19. The method of claim 12, wherein the frequency cap is adjusted based on the type of endorsement generating the sponsored story.

20. The method of claim 10, further comprising:
receiving a second sponsored story specification from the node administrator;
and automatically proxy bidding for the display of a sponsored story generated in accordance with the second sponsored story specification to one or more members of the social network;
wherein the bidding algorithm for the first and second sponsored stories share a common budget and time duration.

21. The method of claim 12, further comprising:
determining if the bidding algorithm cannot fully expend the fiscal budget by the end of the time duration; and, upon such a determination;
automatically dynamically generating backfill for the node, the backfill being capable of generating endorsements; and
automatically proxy bidding via the bidding algorithm for the display of the backfill to one or more members of a social network.
